(19) United States
(12) Patent Application Publication
(10) Pub. No.: US 2020/0324208 A1
(43) Pub. Date: Oct. 15, 2020

(54) RECOGNITION AND CONTEXTUALIZATION OF INTERACTIONS IN AN ONLINE SOCIAL NETWORK

(71) Applicant: Microsoft Technology Licensing, LLC, Redmond, WA (US)

(72) Inventor: Ryan Ronald CLEVEN, North Vancouver (CA)

(21) Appl. No.: 16/384,138

(22) Filed: Apr. 15, 2019

(51) Int. Cl. A63F 13/795; A63F 13/87; A63F 13/798

(52) U.S. Cl. CPC A63F 13/795; G06Q 50/01; A63F 13/798; A63F 13/87

(57) ABSTRACT

A method of promoting social relationships initiated during online activities includes identifying a first user using a first game application in data communication with a network and a second user using a second game application in data communication with the network, determining when the first user and the second user are actively engaged with one another during a shared social event in the first game application and the second game application, assigning a value to the shared social event in the interactive game application, and awarding the value of the shared social event in the interactive game application to a relationship profile between the first user and second user.

### BACKGROUND

### Background and Relevant Art

Online gaming has become a standard of the computer game industry. The ability to play against other humans over a network allows greater freedom and creativity in the user's experience with the game. All types of games are played online and even conventionally single-player action games are introducing spectating or assistance mechanics to enable greater player engagement online.

Online gaming, however, is heavily dependent upon pre-existing relationships. Finding and joining a group of similarly skilled users with similar gameplay interests has conventionally required offline introductions and prior friendship or relationship with the other individuals. Further, inviting and joining other players in a particular game conventionally requires those other players to have positively confirmed a “friendship” with the first user in order to allow the users to find one another in a game.

### BRIEF SUMMARY

In some embodiments, a method of promoting social relationships initiated during online activities includes identifying a first user using a first game application in data communication with a network and a second user using a second game application in data communication with the network, determining when the first user and the second user are actively engaged with one another during a shared social event in the first game application and the second game application, assigning a value to the shared social event in the interactive game application, and awarding the value of the shared social event in the interactive game application to a relationship profile between the first user and second user.

In some embodiments, a game system for promoting social relationships initiated during online activities includes a server in data communication with a network. The server includes one or more processors and a hardware storage device in data communication with the one or more processors. The hardware storage device has instructions stored thereon that, when executed by the processor cause the processor to identify a first user on an online game platform and a second user on the online game platform, determine when the first user and the second user are actively engaged in a first interactive game application and second interactive game application during a shared social event in on the online game platform, assign a value to the shared social event in the interactive game application, and award the value of the shared social event in the interactive game application to a relationship profile between the first user and second user on the online game platform.

In some embodiments, a method of promoting social relationships initiated during online activities includes identifying a first user on an online game platform and a second user on the online game platform, determining when the first user and the second user are synchronously engaged with an interactive game application during a shared social event in the interactive game application on the online game platform, assigning a value to the shared social event in the interactive game application, awarding the value of the shared social event in the interactive game application to a relationship profile between the first user and second user on the online game platform, and presenting the relationship profile in an interface to the first user.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the disclosure may be realized and obtained by means of the instruments and combinations particularly pointed out in the appended claims. Features of the present disclosure will become more fully apparent from the following description and appended claims or may be learned by the practice of the disclosure as set forth hereinafter.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example embodiments, the embodiments will be described and explained with additional specificity and detail through the use of the accompanying drawings in which:

FIG. 1 is a system diagram of a game platform, according to at least one embodiment of the present disclosure;

FIG. 2-1 is a hierarchical diagram of the game platform of FIG. 1, according to at least one embodiment of the present disclosure;

FIG. 2-2 is a hierarchical diagram of a cross-platform system, according to at least one embodiment of the present disclosure;

FIG. 3 is a flowchart illustrating a method of promoting social engagement in online interactions, according to at least one embodiment of the present disclosure;

FIG. 4 is an example relationship profile, according to at least one embodiment of the present disclosure;

FIG. 5-1 is an interface presenting relationship profile information, according to at least one embodiment of the present disclosure;

FIG. 5-2 is another interface presenting relationship profile information, according to at least one embodiment of the present disclosure; and

FIG. 6 is a system diagram of a game platform with cloud gaming, according to at least one embodiment of the present disclosure.

### DETAILED DESCRIPTION

This disclosure generally relates to devices, systems, and methods for tracking online relationships between users. More particularly, the present disclosure relates to the identification of relationship types between users by recognizing and contextualizing online interactions between users on a game platform. For example, conventional individual recognition systems identify achievements or other activities performed in a game application by a user on an online platform. These achievements can be visible to other users to identify common gameplay experiences. In other conventional social systems, users can identify and confirm other users of the online platform as “friends”. The online status and achievements of these friends may then be highlighted or delivered to the user. In each instance, no information of the specific relationship or shared experiences on the online platform or game applications played on the game platform is tracked or provided to the user.

In some embodiments, an online platform can track the online active engagement of a user with other users to help develop social bonds that extend beyond the gameplay session, beyond the game application, or even beyond the online platform. Active engagement can be synchronous or asynchronous engagement. For example, synchronous engagement includes playing a game with another user in a party, on a team, in an identified gameplay region, against one another in a competitive mode, or social communication while playing or spectating a game application. Synchronous engagement allows the realization of “high five moments” or other shared gameplay experiences that produce memorable experiences that are related to the experience of playing with the other user, specifically, and facilitate the creation of a social bond between the users. Asynchronous engagement allows experiences to be shared as each user is available on their own schedule, but retains a shared game state and shared experience.

In an example, synchronous engagement includes playing a game with another user while partied in the game. The users do not need to have previously identified or confirmed one another as friends in the game or on the online platform. The online platform can track the synchronous engagement of any users that engage on the platform. Because the online platform tracks only those users that engage synchronously or in real-time, the online platform does not need to track the activity of all users relative to one another. For example, users that are partied in a group for the purposes of exploration or combat in a massively multiplayer online role-playing game (MMORPG) may have higher degrees of coordination and communication that facilitate the development of social bonds. While the users may not be confirmed friends, the online platform tracks the experiences of the users while synchronously engaged, such that match victories, successful defenses, shared achievements, or party-based social events or milestones are identified and credited toward the relationship of the users without active confirmation steps taken by the users.

In another example, synchronous engagement includes users that are partied in a squad for a first-person shooting game application or on a team in a virtual sport game. Users that are grouped on a competitive team may necessarily work cooperatively toward a goal. Achievement of that goal, irrespectively of the degree of verbal or typed communication, may create memorable moments that facilitate a social bond with the other users.

In a further example, the users need not be partied or grouped, but rather may be in proximity to one another during a shared social event in the game environment, such as within a city, a zone, a region, or within a nominal in-game distance from one another. Some open world online games allow users to play and move in a shared game environment. Player-vs-environment (PvE) global events in the game environment, such as a timed or random enemy attack, allows for individual users to work cooperatively in an organic and dynamic fashion toward a common goal of overcoming the global event. In at least one example, the computer-controlled enemy of the player characters may attach a settlement unannounced, and the player characters can respond to and repel the threat. All users engaged in the defense of the settlement share a common emergent experience that can facilitate a social bond between those users, irrespective of game platform friend status.

In yet another example, the threat in a game may, instead of being computer-controlled, be another player character. In player-vs-player (PvP) games, modes, servers, regions, etc., individual player characters are under the threat of attack from other player characters. In some games, users may coordinate and plan large raiding parties to assault the opposing user factions. In such examples, the users may share a preexisting social connection, either confirmed friends in the game or on a forum, that assists in coordinating such an assault. In some instances, however, the group may form spontaneously, and users may join into a raiding group already underway without any prior engagement with those users.

In PvP engagements, the users may experience achievements or memorable events both with cooperating users from the same faction and with opposing users from a competing faction. A user may experience a defense from an opposing player character on multiple occasions, forming a social bond based on mutual respect (or rivalry) for the abilities and skills of that opposing user.

In still further examples, users may spectate other users playing a game or engage in other social interactions within an online game application outside of conventional “goal-based” gameplay. For example, in some electronic sports (eSports) games, players will enter a spectator lobby to observe the gameplay of another user or team of users. In such examples, social engagement through chat with the spectated players or with other spectators may facilitate the formation of social bonds. In at least one example, the social engagement may occur across different software applications, such as a first application that a first user engages with to play a game and a second application that allows a second user to spectate and communicate with the first user.

In another example, in an MMORPG, a user may engage in economic activities, trading or crafting objects with a large variety of other users. The learning of certain enchantments or crafting of certain objects may require significant commitments of the part of a user, and some users may develop preferences in the other users with whom they trade or otherwise engage economically in a game.

In yet another example, a user may capture a game state while playing a game and save the associated game state information. The game state information may be distributed on a server or the platform to allow other users to duplicate the conditions of the game and experience the exact same situation in the game as the first user.

In each example, the users may not be confirmed friends in the game or on the online platform. The active engagement of a user with other users in a party, a group, a region of the game environment, a gameplay mode, a game state, or other aspects of an individual game can arise organically. Tracking and contextualizing those engagement between the users can identify and reward emergent social bonds. Developing meaningful social bonds within an online platform can encourage new friendships, provide suggestions for new experiences, and improve the platform experience for the users.

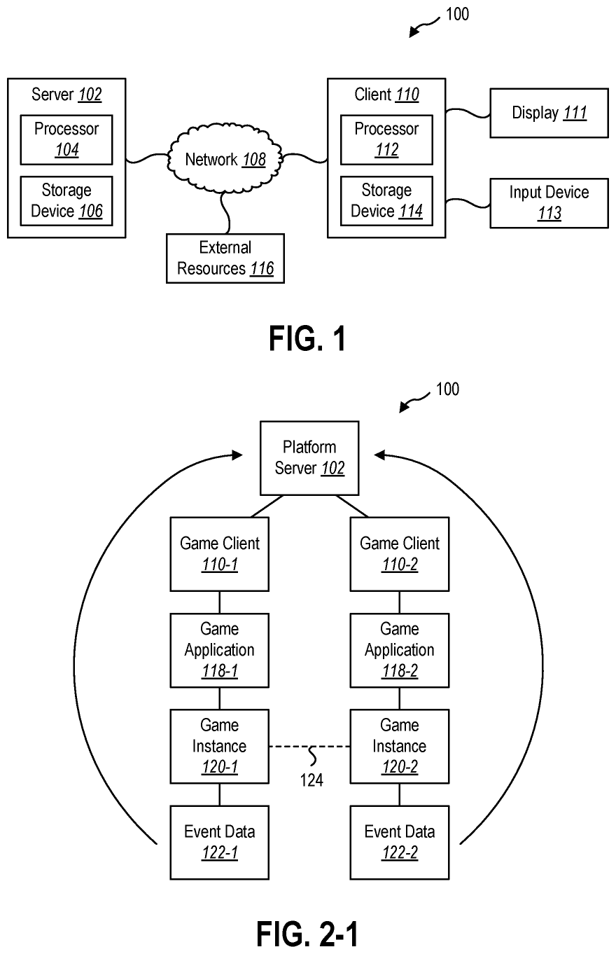

FIG. 1 is a schematic representation of a platform system 100 for providing and tracking gameplay experiences for a user. The online platform is hosted on a server 102 including a server processor 104 and a server hardware storage device 106. The server processor 104 is in data communication with the server hardware storage device 106, and the server hardware storage device 106 can include instructions stored thereon that, when executed by the server processor 104, cause the server processor 104 to perform one or more of the methods described herein. A hardware storage device includes any non-transient storage mechanism, such as solid stage storage, platen-based storage, optical disc-based storage or other storage mechanisms.

The server 102 is in data communication with a network 108. The network 108 allows communication with one or more clients 110 including client processors 112 configured to run game applications. The game applications may be stored on a client hardware storage device 114 of the client 110, which is in data communication with the client processor 112. The game application includes visual information presented to the user on a display 111, such as a television, desktop computer display, laptop display, tablet computer display, smartphone display, head-mounted display, or other graphical display. The client 110 is further in communication with an input device 113 that allows the user to provide input commands to the client 110 to interact with the game application.

In some embodiments, the shared social event that is experienced by the users, such as those described above, is identified on the client 110 and the event may be communicated to the server 102. In other embodiments, the shared social event that is experienced by the users is identified on the server 102 side and the client 110 may subsequently receiving information from the server 102 regarding the event and/or any changes in relationship status with another user.

The network 108 may further provide communication with third-party or other external resources 116. The server 102 and/or the client 110 may communicate with the external resources 116. In some examples, the external resources 116 can include

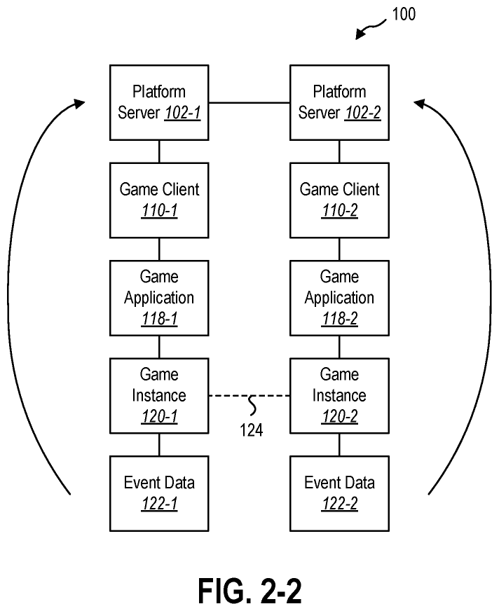

FIG. 2-1 is a hierarchical diagram illustrating the structure of the online platform system 100. The platform server 102 is in data communication with a plurality of clients, such as the first game client 110-1 and second game client 110-2. For example, the platform server 102 may be part of a video game or social network platform (i.e., MICROSOFT XBOX LIVE, NINTENDO CONNECT, SONY PLAYSTATION NETWORK, GOOGLE STADIA, APPLE ARCADE, VALVE STEAM, TWITCH, ELECTRONIC ARTS ORIGIN) or an application specific platform. Each of the game clients 110-1, 110-2 has a processor and hardware storage device (as described in relation to FIG. 1) that allows the game clients 110-1, 110-2 to run a game application 118-1, 118-2. The game application 118-1, 118-2 is in communication with the platform server 102 through the clients 110-1, 110-2.

In some embodiments, the first game application 118-1 and second game application 118-2 are copies of the same application. For example, the first game application 118-1 and second game application 118-2 may be different copies of HALO: COMBAT EVOLVED. In other embodiments, the first game application 118-1 and second game application 118-2 are different applications that allow interaction within a shared gameplay space or interaction through spectating and/or communication of the other application. In yet other embodiments, the first game application 118-1 may be a copy of a game application run on the first client 110-1, while the second game application 118-2 may be an application that allows mirroring of the first game application to the second client 110-2. For example, the first client 110-1 may execute the first game application 118-1 in a local multiplayer mode, while the second game application 118-2 allows the second client 110-2 to communicate with the first client 110-2 to display and interact with the first game application 118-1.

In some embodiments, the game clients 110-1, 110-2 are local to the users. For example, the first game client 110-1 may be local to a first user and the second game client 110-2 may be local to a second user, while the platform server 102 is remote to both the first user and second user. In other embodiments, the game clients 110-1, 110-2 are remote from the users. For example, the game clients 110-1, 110-2 may be in data communication via a network to a display and/or input device of the users. In at least one example, the users may engage with the game clients through a cloud networking service, as will be described in more detail below.

Each game application 118-1, 118-2 creates a game instance 120-1, 120-2. For example, a first game instance 120-1, 120-2 can be within a shared open world coordinated on the platform server 102 in which a first user controls a first player character through which the first user interacts with the shared open world, while the second game instance 120-2 allows the second user to control a second player character through which the second user interacts with the shared open world. In another example, a first game instance 120-1, 120-2 can be a shared event (such as a dungeon, raid, mission, race, sports event, etc.), with only a subset of players in communication with the platform server 102 included in the shared event. Within the shared event, the first game instance 120-1 allows the first user to control a first player character, while the second game instance 120-2 allows the second user to control a second player character. In at least one example, the game instances 120-1, 120-2 may be a subset of an open world experience. For example, the game application 118-1, 118-2 may be an open world game, while the game instances 120-1, 120-2 may include only a subregion of the in-game open world and provide a limited experience to only certain player characters.

In some embodiments, the game instances 120-1, 120-2 are synchronized through the platform server 102. For example, the platform server 102 receives game state information from the first game client 110-1 regarding the first game instance 120-1 and transmits the game state information from the first game client 110-1 to the second game client 110-2, such that the actions of the first user are represented in the second game instance 120-2. The platform server 102 can, thereby, coordinate the interactions of many users with a large in-game environment.

In other embodiments, the game instances 120-1, 120-2 are synchronized in a direct connection 124. In some embodiments, the game clients 110-1, 110-2 may be in communication with one another through a network independently of the platform server 102 (such as a direct peer-to-peer connection or a private server) that allows the game instances 120-1, 120-2 to shared state information without limitations of other processing load or network traffic through the platform server 102. For example, a real time strategy game that includes the first user playing against the second user exclusively may benefit from a direct connection 124 through a network.

The game instances 120-1, 120-2 generate event data 122-1, 122-2 regarding a shared social event that is experienced by the first user and the second user in the game. In some embodiments, the event data 122-1, 122-2 relates to predetermined social events in the game provided by a developer of the game application 118-1, 118-2. For example, the developer may identify the completion of a level, the defeat of an endboss, or the completion of a competitive tournament, as a predetermined social event. In other examples, the social event may be determined dynamically through player character or user behavior. In at least one example, a social event may be determined by users completing an event in the game in a shorter duration than other users (i.e., a “speedrun”). In such examples, the event may be established by shared game state information.

In some embodiments, the social event is repeatable. For example, a first user may experience the shared social event more than once with different users or more than once with the same user. In one example, a first user may complete or experience the shared social event with a plurality of users, forming a social bond with each individual user. In another example, the first user may complete or experience the shared social event repeatedly with a second user, strengthening and building the social bond between the first user and second user.

In other embodiments, the social event is only able to be experienced once. For example, the social event may be playing a game cooperatively when a plot twist occurs, such as the death of primary character. The plot twist has an emotional impact the first time, and the shared experience of that plot twist forms a touchstone between the players. However, replaying that portion of a game with the same user may have a lessened impact, and therefore, provide less support to a social bond between the users. In some embodiments, subsequent playthroughs may not yield event data 122-1, 122-2. In other embodiments, the event data 122-1, 122-2 may be lessened for each subsequent completion of the shared social event.

In some embodiments, the first event data 122-1 and second event data 122-2 are symmetrical. For example, the first event data 122-1 and second event data 122-2 may be the same for the first user and for the second user when the first user and second user experience a shared social event together. In other embodiments, the first event data 122-1 and second event data 122-2 are asymmetrical. For example, the first event data 122-1 for a first user and the second event data 122-2 for a second user may be different if the first user had previously experienced the social event and the second user had not, or if the first user and second user had previously experienced the social event with other users.

In some embodiments, the event data 122-1, 122-2 for the first user and second user is transmitted 126 to the platform server 102. The event data 122-1, 122-2 is received by the platform server 102, and the event data 122-1, 122-2 is registered to a relationship profile of the first user and second user.

FIG. 2-2 is a hierarchical diagram illustrating another structure of the online system 100. In some embodiments, the online system 100 may provide cross-platform activity. For example, the system 100 may include a first platform server 102-1 and a second platform server 102-2 that are in data communication with one another. A first user may be playing a game application 118-1 that is communicating with the first platform server 102-1 and the second user may be playing a game application 118-2 that is communicating with the second platform server 102-2. The first platform server 102-1 and second platform server 102-2 can share information to sync game instances 120-1, 120-2 or event data 122-1, 122-2 between the platforms to allow the development of social relationships and relationship profiles according to the present disclosure across different platforms.

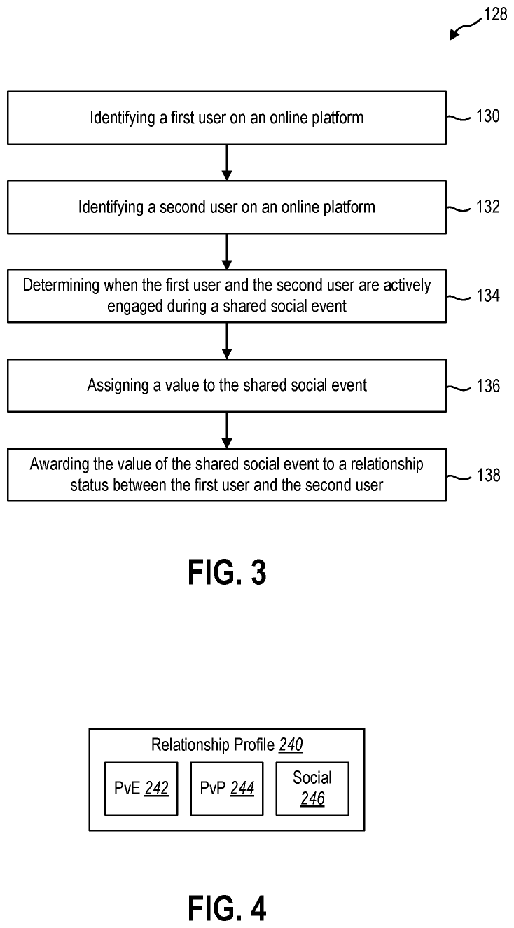

FIG. 3 is a flowchart illustrating an embodiment of a method 128 of contextualizing online interactions. In some embodiments, the method 128 may be employed at a server level. For example, the method 128 includes identifying a first user on an online platform at 130 and identifying a second user on the online platform at 132. The method 128 further includes determining when the first user and second user are actively engagement during a shared social event at 134. For a first user and second user to be actively engaged during a shared social event, the users do not need to be grouped or partied prior to the event. The users do not need to have any prior confirmation of friendship or prior engagement. The platform can track when the users are engaged toward a common goal and/or when the users achieve that goal.

In some embodiments, the users are actively engaged when the first user and second user are in group or party within a game instance. For example, merely being in a platform chat or party does not necessitate engagement toward a goal. In fact, one or more of the players may not even be present at the computer or game console. When partied in a game instance, the users are engaged in the game environment and controlling player characters. In other embodiments, the users are actively engaged during a shared social event when the users complete a quest or other mission in the game. For example, a first user is more likely to remember and play with a second user when the first user has had success in the game previously with the second user. In a particular example, teammates in a sports game may experience a shared social event at the end of match in which they are victorious. In another example, the teammates may experience a shared social event when a first user assists a second user scoring a goal. While scoring the goal unassisted may be credited toward individual statistics or achievements in the game, an unassisted goal does not provide social value to a relationship between the first user and second user.

While the users may be in a party to work cooperatively toward the goal, some games allow cooperative play based on proximity in the game world or shared quests from a non-player character (NPC) without the users entering an explicit confirmation of grouping together. For example, global events in open world game environments may allow the cooperative (or competitive) play of any player characters in that region of the game environment. For example, any user controlling a player character that simultaneously engages in the defense of a town in an MMORPG may be recognized as engaging in the shared social event with other users at the time. If the same town is attacked at a later time, the users engaged in that defense will be actively engaged in a different shared social event.

The method 128 also includes assigning a social value to the shared social event at 136 and awarding the social value of the shared social event to a relationship status or profile between the first user and the second user at 138. In contrast to conventional experience and leveling systems in games and in social networks, the methods and systems of the present disclosure surface and reward relationships between users based on shared experiences and events and, therefore, all events are valued in the context of at least two users. In other words, a user playing a single-player game will not experience shared social events and cannot accrue the social value of the events.

For example, FIG. 4 illustrates a relationship profile 240 between a two users, according to the present disclosure. In some embodiments, any and all social events will contribute to a single relationship profile 240 total. For example, two users completing a level on an Easy difficulty setting while playing cooperatively may accrue 15 social experience points (SXP), while the same two users completing the same level on a Hard difficulty setting may accrue 45 SXP because of the greater challenge overcome together on the harder setting. Additionally, the users could build a similar level of relationship profile by replaying and completing the level on Easy three times. In at least one example, the second playthrough may provide less SXP, however, encouraging the users to increase the difficulty of the game or try other experiences in the game or in other games.

In other embodiments, the relationship profile 240 may additionally or alternatively include a list of the shared social events completed by the users. For example, the relationship profile 240 may include the total SXP and/or a list of the events that contribute to that SXP, such as “complete a level on Easy”, “complete a level on Hard”, “defend the base”, or other social events and the game in which the shared social event was completed. While the quantification of the social relationship in the relationship profile 240 may provide a summary of the social relationship, the individual events and games can provide a more effective connection to the memory of the event, promoting and encouraging the social relationship between the users.

In some embodiments, the SXP may be assigned to the relationship profile 240 in a total value. In other embodiments, the SXP may be assigned to one or more subsets of the relationship profile 240. For example, the relationship profile 240 total value may reflect the amount of shared social experiences on the platform, while the subcategories contextualize the types of shared social experiences on the platform.

In a first example, a subcategory of the relationship profile 240 may be a PvE subcategory 242. A shared social event involving two or more users overcoming a game challenge controlled or managed by the game application, such as a computer-controlled boss enemy, may have a SXP value specific to the PvE subcategory 242. In other examples, a shared social event involving two or more users playing cooperatively on the same team in a sports game against another team may provide the users with SXP for the PvE subcategory 242.

In another example, a subcategory of the relationship profile 240 may be a PvP subcategory 244. A shared social event involving two or more users overcoming a game challenge controlled or managed by another user, such as fighting another player character, may have a SXP value specific to the PvP subcategory 244. In some examples, the subcategories may have further subcategories (e.g., sub-subcategory) such as designating whether the second user was playing in a PvP event cooperatively or as an enemy. When a first user engages in a PvP assault on an opposing faction's city in an MMORPG, the first user may accrue PvP SXP with other users that fight alongside the first user, increasing the level of the first user's relationship profile with those users in a relationship profile SXP total and in a cooperative PvP sub-subcategory. However, the first user may additionally increase a level of the first user's relationship profile with a second user defending the city when that second user fights the first user in the game. This SXP may be awarded to a competitive PvP sub-subcategory. A user may be able to view such competitive sub-subcategories to identify (and in some cases further develop) rivalries with recurring opposing users over time.

In the previous example of playing a sports game, a player may accrue a first amount of SXP with teammates when victorious in the match and a second amount of SXP with the opponents if the opponents are user-controlled. In this manner, SXP may be assigned to different subcategories or different relationships for the same events in a game. Additionally, the amount of SXP accrued for the different subcategories may be different, as the events of sharing a win with teammates and engaging in a rivalry match against an opponent are discrete shared social events.

In another example, the relationship profile 240 may have a social subcategory 246 that helps contextualize social interactions in a game that occur outside of conflict-based (PvE or PvP) gameplay. For example, direct messaging within a game may be captured here with 1 SXP awarded to the social subcategory 246 for every five direct messages sent between users. In another example, each trade of economic resources made in the game may accrue 5 SXP to the social subcategory 246 of the relationship profile of the first and second users. In yet another example, communications made between a first user and a second user made while the first user is spectating a second user in a game may have an increased SXP associate with the communication, such as 1 SXP per message sent.

In this way, the platform can quantify and contextualize the types of cooperative, competitive, and social engagement between users. By surfacing, quantifying, or presenting the relationship profile values to a user, the user may identify potential new friends, patterns in gameplay choices, preferred users for different game or gameplay types, or other previously unknown behaviors or potential social bonds.

For example, the platform may surface a second user that a first user has grouped with several times to overcome a challenging raid in a game. The user may not be friends, but the first user may view their relationship profiles and identify the second user as a player with whom the first user has enjoyed great success in the game, spurring the first user to contact and invite the second user to join in a future game. In another example, when a first user begins playing a new game application, the user or platform may review the first user's relationship profile with other users and recommend invitations for those users that may enjoy that game's gameplay type. In at least one specific example, the user or platform may identify a frequent and successful PvE teammate of the first user from other games, which the first user could invite to their game instance of the new game, despite the two users having no history of the playing that game, yet.

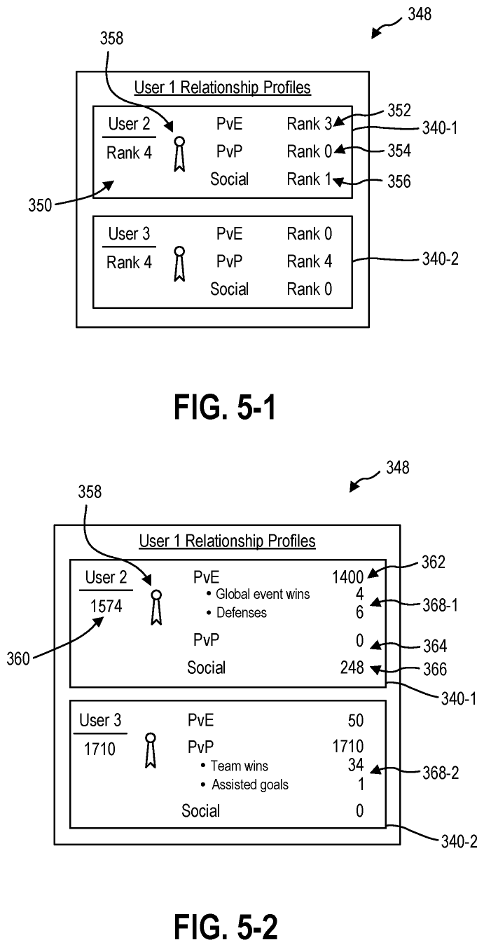

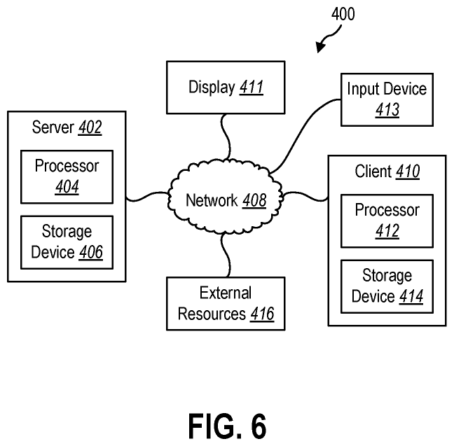

FIG. 5-1 is an example interface 348 for User 1 that presents relationship profiles for a User 2 and a User 3. The interface 348 for User 1 includes a presentation of a relationship rank 350 for each of User 2 and User 3. The relationship rank 350 of User 1 with User 2 is based upon the total SXP of accrued for the relationship of User 1 and User 2, and the relationship rank 350 of User 1 and User 3 is based upon the total SXP of accrued for the relationship of User 1 and User 3. User 1 may view the interface 348 to quickly and easily identify the online relationship User 1 has with each of User 2 and User 3. The relationship rank 350 represents not merely the time spent with another user, but rather a total of the experiences had with the other user.

In some embodiments, the relationship rank 350 includes subranks based on the relationship profile subcategories, such as a PvE subrank 352, a PvP subrank 354, and a Social subrank 356. User 1 may view the subranks of the interface 348 to quickly and easily identify type of online relationship User 1 has with each of User 2 and User 3. For example, while both the relationship rank 350 of User 1 and User 2 and the relationship rank 350 of User 1 and User 3 are both currently Rank 4, User 1 has very different histories of playing with other users.

The first relationship profile 340-1 (User 1 and User 2) includes a PvE subrank 352 of Rank 3. A PvE Subrank 3 may reflect a number of shared social events in a PvE context between User 1 and User 2. Meanwhile the PvP subrank 354 is currently a Subrank 0, indicating little or no completed shared social events between User 1 and User 2 in a PvP context. While this may indicate that User 1 and User 2 have not played in a PvP context, it can also indicate little to no success or completion of events. In either example, a Subrank 0 in PvP Subrank 354 indicates that User 1 and User 2 have little to no shared or memorable experiences in that gameplay type. The first relationship profile 340-1 includes a Social Subrank 356 of Subrank 1. This subrank indicates success in non-combat or other social or economic endevours on the game platform between User 1 and User 2. The first relationship profile 340-1, therefore, conveys a relationship between User 1 and User 2 that would lend itself to role-playing, open world PvE experiences, such as an MMORPG.

The second relationship profile 340-2 (User 1 and User 3) includes a PvE subrank 352 of Rank 0. A PvE Subrank 0 may indicate little or no completed shared social events between User 1 and User 3 in a PvE context. Meanwhile the PvP subrank 354 is currently a Subrank 4, indicating a number of completed shared social events between User 1 and User 3 in a PvP context. While this may indicate that User 1 and User 3 have played more in a PvP context than PvE, it can also indicate a much higher success rate in a PvP context, providing greater context for the types of experiences in which User 1 and User 3 excel. The second relationship profile 340-2 includes a Social Subrank 356 of Subrank 0. The second relationship profile 340-2, therefore, conveys a relationship between User 1 and User 3 that would lend itself to dedicated PvP experiences, such as individual or squad-based first-person shooters, battle royale games, multiplayer online battle arena (MOBA) games, or other competitive games against other player characters.

Because the relationship profile 340-1, 340-2 is based on shared social events and experiences, the relationship profile values and ranks 350 representing the nominal value may deteriorate over time in the absence of ongoing interactions. For example, the SXP accrued in a relationship between a first user and a second user may decrease at a constant rate over time, while completing shared social events will increase the value back to a prior level. In other examples, the SXP in the relationship may decrease at an increasing or exponential rate over time. In yet other examples, the deterioration of the SXP in a relationship may begin only after a predetermined period of inactivity. In such examples, the SXP value of the relationship may remain constant for a day, a week, a month, or longer, before beginning to decrease. In at least one example, completing a shared social event may reset the inactivity period. In another example, actively engaging with the other user may reset the inactivity period, whether a shared social event is completed (and hence SXP is earned) or not. In further examples, the deterioration of the SXP may begin immediately after the completion of a shared social event. For example, the deterioration of the SXP may be exponential, but the rate resets to the lowest rate after each shared social event, albeit without an inactivity period grace period.

The deterioration of the SXP value of the relationship may cause the relationship rank 350 to decrease over time. In some embodiments, the relationship ranks 350 may have increasing SXP requirements between ranks. For example, Rank 1 may require 50 SXP, while Rank 2 requires 125 SXP, and Rank 3 requires 300 SXP. In such examples, a constant rate of SXP deterioration will cause the decrease from Rank 3 to Rank 2 to take more time than the decrease from Rank 2 to Rank 1, or from Rank 1 to having no relationship rank 350 (e.g., Rank 0 or no relationship profile 340-1, 340-2 present in the interface 348).

However, this may feel punitive to users, as the loss in relationship ranks 350 may appear to accelerate. In some embodiments, the loss of rank, therefore, may be done as a percentage of the rank over time. In this manner, each day (after a period of inactivity, if required), users may lose 20% of their current relationship rank 350 irrespective of SXP accrued. For example, if users have 320 SXP, those users would have a Rank 3 relationship, in the above example. However, it would take the users five days (at a 20% rank loss rate) to fall from Rank 3 to Rank 2. It would also take the users five days to fall from Rank 2 to Rank 1. In at least one example, once two users establish a social bond on the online platform by attaining a Rank 1 relationship profile, the users may retain the Rank 1 as a minimum rank. In other words, the users may have to accrue at least 50 SXP to establish a Rank 1 relationship, but that relationship may be established indefinitely so that the history of those shared social events are not deleted from their relationship profiles 340-1, 340-2 or from the interface 348 presenting that information to the users. This may allow users that played a single game together to reconnect after a period of time playing other games and not engaging with one another.

In some embodiments, the loss of SXP associated with a Subrank, or the levels of the Subrank itself, may decrease in any fashion described in relation to the relationship rank 350, as well.

The interface 348 may further present a visual representation of the relationship rank 350, as well. In some embodiments, a relationship icon 358 can be presented to a user to represent the extent of the social relationship with another user. In the illustrated example in FIG. 5, the interface 348 presents the same relationship icon 358 for both of the Rank 4 relationship profiles 340-1, 340-2. However, the relationship icon 358 may further reflect the type of the social relationship based on the subranks 352, 354, 356 in the relationship profile 340-1, 340-2.

In some embodiments, the relationship icon 358 may function as a shorthand designation for each relationship rank 350. The relationship icon 358 may appear adjacent the username of the second user when a first user sees that username or (player character controlled by that user) in the game application or platform. For example, the platform may track and identify a relationship profile 340-1 between User 1 and User 2. When User 1 encounters User 2 in a game environment, for example, an open world game environment, the username associated with User 2's player character may include the relationship icon 358 informing User 1 of a history of playing with (and succeeding with) User 2 in social events. This may encourage User 1 to group with or otherwise join with User 2 for cooperative play. In other examples, a relationship icon may identify another user as having a rivalry with User 1, warning User 1 to stay away or to potentially engage the rival user in PvP play and reinforce the rivalry.

In contrast to a conventional system that tracks gameplay time or shared achievements, a relationship profile according to the present disclosure allows for a greater level of depth and contextualization of online relationships that can enable more personalized experiences, in-game or in-platform rewards, confirmed friend recommendations, group or party recommendations, game application recommendations, or gameplay type recommendations.

In some embodiments, increases in relationship rank 350 and subranks 352, 354, 356 may provide platform- or game-based rewards. For example, increasing an SXP total, relationship rank 350, or subrank 352, 354, 356 with another user may provide experience or resource benefits within a game. For example, a game application may award a 5% experience increase for completing experience-granting missions while actively engaged with another user with whom the player has a Rank 2 relationship rank 350, reinforcing and rewarding the type of relationship. In another example, a game application may award a 10% experience increase for completing experience-granting missions in cooperative PvE play when actively engaged with another user sharing a PvE subrank 352 of Rank 2, reinforcing and rewarding the type of relationship. In yet another example, a game application may award a 10% resource increase (or cost decrease) for completing social, economic, or crafting goals in social (non-combative) play when actively engaged with another user sharing a Social subrank 356 of Rank 2, reinforcing and rewarding that particular type of relationship.

In other embodiments, the relationship profile 340-1 between two users may be used to gate content. For example, a particular mission, dungeon, raid, region, resource, item, or cosmetic option may be only accessible with actively engaged (i.e., grouped or in proximity to) another user with whom the user has a minimum relationship rank 350. In other examples, a particular mission, dungeon, raid, region, resource, item, or cosmetic option may be only accessible with actively engaged (i.e., grouped or in proximity to) another user with whom the user has a minimum relevant subrank 352, 354, 356.

In some embodiments, the relationship profile 340-1, 340-2 may allow a game application or a platform to recommend experiences with other users. For example, the relationship profile 340-1 of User 1 and User 2 may indicate to a game application to recommend to User 1 joining with User 2 to attempt a new PvE experience recently included in a content patch, further building upon the existing social relationship between the users. In another example, the relationship profile 340-2 of User 1 and User 3 may indicate to a game application to recommend to User 1 joining with User 3 (and not User 2) to attempt a new map of the PvP gameplay recently included in a content patch or a new PvP mode the users have not actively engaged in together, further building upon the existing social relationship between the users.

At a platform level, the relationship profile 340-1 of User 1 and User 2 may indicate to a game platform to recommend to User 1 joining with User 2 to try a new cooperative role-playing game that User 2 has been playing, further building upon the existing social relationship between the users. In another example, the relationship profile 340-2 of User 1 and User 3 may indicate to a game platform to recommend to User 1 joining with User 3 to play an eSport game that both play but have not played together, further building upon the existing social relationship between the users.

In yet other embodiments, the relationship profile 340-1, 340-2 may allow a game application or a platform to improve matchmaking with other users. Conventional systems use metrics measured from a game to determine a skill level or experience level for a user to place that user in a match with players of similar abilities. However, the relationship profile 340-1 of User 1 and User 2 may indicate to a game application that User 1 and User 2 demonstrate greater success, communication, or teamwork in a PvE challenge, and the game may preferentially group them together above “random” players if both are available, leveraging the existing social relationship between the users. In another example, the relationship profile 340-2 of User 1 and User 3 may indicate to a game application that User 1 and User 3 demonstrate greater success, communication, or teamwork in a PvP setting than individually, allowing User 1 and User 3 to be placed in a higher skill ranking when actively engaged, further leveraging the existing social relationship between the users.

In other embodiments, the interface 348 may provide a quantification of the SXP for each relationship profile 340-1, 340-2 and/or subcategory. For example, the interface 348 of FIG. 5-2 presents the same relationship profiles 340-1, 340-2 as FIG. 5-1, but instead of rank and subranks, the relationship value 360 and subcategory values 362, 364, 366 are shown. In some instances, a user may drill down into each of the subcategories to access a list of the complete shared social events to further contextualize their relationship with the other users. For example, the shared social event statistics 368-1, 368-2 in the relationship profile 340-1, 340-2 can include the total number of wins, defenses, captures, goals, assists, etc. depending on the variety of games that are experienced together between the users.

As shown in FIG. 5-2, the subcategory values 362, 364, 366, such as those depicted in the first relationship profile 340-1, may total a different value than the relationship value 360. For example, one or more of the shared social events may have a value associated with that shared social event that is assigned to the relationship value 360 while also having individual subcategory values that are, in sum, greater than the value assigned to the relationship value 360.

In the second relationship profile 340-2, however, the relationship value 360 is the same as the PvP subcategory value 364, while the second relationship profile also has a 50 SXP score in the PvE subcategory value 362. Note that in FIG. 5-1, the second relationship profile 340-2 has a PvE subrank 352 of 0, because the PvE subcategory value 362 shown in FIG. 5-2 has not yet risen to the minimum value to attain a PvE subrank 352 of 1.

In some embodiments, a user may toggle between the ranks and values, or present them simultaneously, in the interface 348. In at least one embodiment, a rank icon 358 may be used to illustrate the relative rank of the relationship profile 340-1, 340-2 even when the relationship value 360 and subcategory values 362, 364, 366 are displayed.

While examples of a system for improving social relationships in online environments have been described in relation to two users playing a game application on individual devices, in some embodiments, the clients may be remote from the users. In at least one embodiment, a system 400 includes a server 402 and clients 410 in communication through a network 408. The server 402 and clients 410 may each have processors 404, 412 and storage devices 406, 414 in data communication with the processors 404, 412, respectively, to perform any of the methods described herein.

In some examples, the client 410 may be a personal computer, a gaming console, a smartphone, or other computing device with the game application stored thereon to allow the processor 412 to execute the game application locally such that the user can view and interact with the game application via a local display and input device. However, in other examples, at least one of the clients may be remote from the display 411 and/or input device 413.

For example, the client 410 may be a remote cloud gaming client 410 that executes the game application and transmits visual information to a remote display 411 to present the visual information of the game application to a user. The user may provide input commands with an input device 413, such as a gamepad, joystick, keyboard, motion sensing device, or other input peripheral to the client 410 by transmitting the input command through the network 408.

In embodiments of a system 400 that utilizes cloud-based clients 410 or in a system with local clients (such as the system 100 described in relation to FIG. 1), the client 410 executing the game application may send game state information to the server 402. The game state information may include any and all relevant information about the current state of the gameplay in the user's game instance. For example, the game state information may include a player character location, player character level, player character experience, player character skills, player character abilities, player character resources, enemy character location, enemy character level, enemy character experience, enemy character skills, enemy character abilities, enemy character resources, game environment, or other information to replicate the exact in-game conditions a first user is experiencing. The game state information may be stored in a storage device 406 of the server 402 and accessed by another client to duplicate the game state of the first client 410.

By duplicating the game state, a first user and a second user may experience the same gameplay challenge or experience asynchronously. In this manner, the users may challenge one another to beat a target time, defeat an enemy with a particular equipment set or ability set, or another user-created challenge. While engaging in these game state challenges may occur asynchronously, the challenges can allow users to share a gameplay experience in a shared social event, thereby enabling asynchronous active engagement between users.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: hardware computer-readable storage media and transmission computer-readable media.

hardware computer-readable storage media includes RAM, ROM, EEPROM, CD-ROM or other optical disk storage (such as CDs, DVDs, etc.), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

It should be understood that any directions or reference frames in the preceding description are merely relative directions or movements. For example, any references to “front” and “back” or “top” and “bottom” or “left” and “right” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method of promoting social relationships initiated during online activities, the method comprising:
identifying a first user using a first game application in data communication with a network and a second user using a second game application in data communication with the network;
determining when the first user and the second user are actively engaged with one another during a shared social event in the first game application and the second game application;
assigning a value to the shared social event in the interactive game application; and
awarding the value of the shared social event in the interactive game application to a relationship profile between the first user and second user.

2. The method of claim 1, the relationship profile having a plurality of subcategories,
wherein assigning the value to the shared social event includes assigning a subvalue in one or more subcategories of the plurality of subcategories, and
awarding the value of the shared social event includes awarding the subvalue to the subcategory of the relationship profile.

3. The method of claim 2, at least one of the subcategories having a plurality of tiers.

4. The method of claim 1, the relationship profile having a plurality of tiers.

5. The method of claim 1, the shared social event being predetermined by the first interactive game application.

6. The method of claim 1, the shared social event being determined at a server level by user activity on a game platform.

7. The method of claim 1, the shared social event being a cooperative gameplay event.

8. The method of claim 1, the shared social event being a competitive gameplay event.

9. The method of claim 1, the value of the shared social event being different on a second occurrence for the first user.

10. The method of claim 1, the first user and second user being actively engaged when the first user and second user are synchronously engaged during the shared social event.

11. The method of claim 1, the relationship profile being independent of a confirmed relationship of the first user and second user.

12. A game system for promoting social relationships initiated during online activities, the system comprising:
a server in data communication with a network, the server including:
one or more processors;
a hardware storage device in data communication with the one or more processors, the hardware storage device having instructions stored thereon that, when executed by the processor cause the processor to:
identify a first user on an online game platform and a second user on the online game platform,
determine when the first user and the second user are actively engaged in a first interactive game application and second interactive game application during a shared social event in on the online game platform,
assign a value to the shared social event in the interactive game application, and
award the value of the shared social event in the interactive game application to a relationship profile between the first user and second user on the online game platform.

13. The system of claim 11, the instructions further including receiving a game state information from the first client and providing a shared game state to the second client, wherein the first user and second user are actively engaged when the second user plays the second interactive game application pursuant to the shared game state.

14. The system of claim 11, further comprising
a first client, the first client including:
one or more processors, and
a hardware storage device in data communication with the one or more processors, the hardware storage device having instructions stored thereon that, when executed by the processor cause the processor to execute a first interactive game application; and
a second client, the first client including:
one or more processors, and
a hardware storage device in data communication with the one or more processors, the hardware storage device having instructions stored thereon that, when executed by the processor cause the processor to execute a second interactive game application.

15. The system of claim 14, further comprising a first display and first input device that are remote to the first client.

16. The system of claim 11, the relationship profile having a plurality of subcategories,
wherein assigning the value to the shared social event includes assigning a subvalue in one or more subcategories of the plurality of subcategories, and
awarding the value of the shared social event includes awarding the subvalue to the subcategory of the relationship profile.

17. The system of claim 11, the server further having instructions stored thereon that, when executed by the processor, assign a rank icon to the relationship profile between the first user and second user.

18. The system of claim 17, the rank icon further being based upon at least one subrank of the relationship profile.

19. The system of claim 17, the rank icon being presented to the first user at a platform level.

20. A method of promoting social relationships initiated during online activities, the method comprising:
identifying a first user on an online game platform and a second user on the online game platform;
determining when the first user and the second user are synchronously engaged with an interactive game application during a shared social event in the interactive game application on the online game platform;
assigning a value to the shared social event in the interactive game application;
awarding the value of the shared social event in the interactive game application to a relationship profile between the first user and second user on the online game platform; and
presenting the relationship profile in an interface to the first user.
